(19) United States
(12) Patent Application Publication
(10) Pub. No.: US 2007/0138224 A1
(43) Pub. Date: Jun. 21, 2007

(54) Actuating device

(75) Inventors: Bernhard Rimmelspacher, Rheinstetten (DE); Siegfried Moehring, Moeglingen (DE); Michael Fischer, Asperg (DE); Joerg Riehle, Asperg (DE)

Correspondence Address: Lipsitz & McAllister, LLC, 755 MAIN STREET, MONROE, CT, 06468, US

(73) Assignee: SCAMBIA INDUSTRIAL DEVELOPMENTS AKTIENGESELLSCHAFT, Schaan (LI)

(21) Appl. No.: 11/591,278

(22) Filed: Oct. 31, 2006

(30) Foreign Application Priority Data
Nov. 3, 2005 (DE) 10 2005 053 177.6

(51) Int. Cl. B60R 9/00; B60R 11/00

(52) U.S. Cl. 224/519

(57) ABSTRACT

In order to improve an actuating device for a trailer coupling, in particular, for actuating a trailer coupling with a ball neck movable between an operative position and a rest position, for example, a locking device of such a trailer coupling, comprising a device base which can be mounted on the vehicle and a lever which is mounted on the device base so as to be movable and can be moved from a starting position, in which no actuation of the trailer coupling takes place, into an actuating position, whereby the trailer coupling is acted upon by means of a movement transfer device, in such a manner that this can be operated as favorably as possible it is suggested that a securing device be provided on the lever which secures the lever against any actuation in the starting position.

The present disclosure relates to the subject matter disclosed in German application number 10 2005 053 177.6 of Nov. 3, 2005, which is incorporated herein by reference in its entirety and for all purposes.

### BACKGROUND OF THE INVENTION

The invention relates to an actuating device for a trailer coupling, in particular, for actuating a trailer coupling with a ball neck movable between an operative position and a rest position, for example, a locking device of such a trailer coupling, comprising a device base which can be mounted on the vehicle and a lever which is mounted on the device base so as to be movable and can be moved from a starting position, in which no actuation of the trailer coupling takes place, into an actuating position, whereby the trailer coupling is acted upon by means of a movement transfer device.

Actuating devices of this type are known from the state of the art. The problem with them is that they cannot be actuated, on the one hand, in an adequately secure manner and, on the other hand, in an ergonomically favorable manner.

The object underlying the invention is, therefore, to improve an actuating device of the generic type in such a manner that this can be operated as favorably as possible.

### SUMMARY OF THE INVENTION

This object is accomplished in accordance with the invention, in an actuating device of the generic type, in that a securing device is provided on the lever which secures the lever against any actuation in the starting position.

The advantage of the solution according to the invention is to be seen in the fact that, with it, any unintentional actuation of the lever and, therefore, of the actuating device can be ruled out.

As a result, it is also possible, for example, to arrange the lever not in a protected area of the vehicle body but rather in any area suitable for its operation.

In principle, the securing device could be designed in the most varied of ways.

For example, it would be conceivable to design the securing device such that it covers the lever in order to prevent any unintentional actuation.

Another solution provides for the securing device to secure the lever, for example, in relation to the bumper unit.

A particularly robust securing of the lever in the starting position is possible due to the fact that the securing device comprises a securing element which can be brought into operative connection with a securing element receiving means on the device base in order to secure the lever on the device base in the starting position.

Such a securing element and a corresponding securing element receiving means may be designed in the most varied of ways.

In order to ensure that the two always transfer into their position interacting with one another, it is preferably provided for the securing element to be acted upon by an elastic force storing means in the direction of its position interacting with the securing element receiving means.

In order to bring about as ergonomic a release as possible of the securing device, it is preferably provided for the securing element to be brought out of operative connection with the securing element receiving means in conjunction with action on the lever.

Such a release of the operative connection is conceivable in the most varied of ways.

One advantageous embodiment provides for the securing device to comprise a releasing element, with which the securing element can be brought into a position out of operative connection with the securing element receiving means.

Such a securing device may be actuated in a particularly favorable manner ergonomically when the releasing element is movable in relation to the lever.

In the simplest case, it is provided for the releasing element to be mounted on the lever so as to be movable.

The releasing element could be a release knob, for example, which can be actuated along with action on the lever.

One particularly favorable solution provides for the releasing element to be a releasing lever which is mounted on the lever, for example, so as to be pivotable.

In this respect, it is particularly expedient when the releasing lever is pivotable in the direction of the lever for the purpose of actuation so that the securing device can be released due to a movement of releasing lever and lever towards one another.

Another advantageous solution provides for the securing element to be brought out of operative connection with the securing element receiving means due to action on the lever in a release direction extending transversely to the direction of movement leading from the starting position to the actuating position.

With this embodiment, no additional releasing lever is, therefore, required but rather an additional movement of the lever itself, namely in a direction which extends transversely to the direction of movement required for reaching the actuating position.

Such a complex movement of the lever is, on the one hand, particularly favorable ergonomically and, on the other hand, still allows the securing device to be effective in the starting position of the lever.

With respect to the arrangement of the lever, no further details have so far been given. It would, for example, be conceivable to still arrange the lever such that it is arranged, for example, in an interior of the trunk so as to be accessible.

It would also be conceivable, for example, to arrange the lever such that it is, for example, accessible after opening an access flap to the vehicle body; this could be a door, a trunk lid or a fuel filler flap.

A particularly favorable solution provides, however, for the lever to be arranged on an outer side of the vehicle body so as to be accessible.

In this respect, it is particularly favorable when the lever is arranged on an outer side of the vehicle body so as to be constantly accessible.

A particularly favorable arrangement of the lever provides for this to be arranged in the area of a bumper unit so that the lever may be arranged in ergonomically favorable vicinity to the trailer coupling.

The actuation of the lever may be realized particularly favorably when the lever is arranged in the area of an underside of the bumper unit.

In principle, the lever may be movable such that the plane of movement extends vertically or at any optional angle in relation to a horizontal or a vertical plane.

One particularly favorable solution provides, however, for the lever to be movable in a plane of movement which forms an angle of at the most approximately 30° with a horizontal plane.

It is even better when the plane of movement forms an angle of at the most 20°, even better an angle of at the most 10° with a horizontal plane.

With such a course of the plane of movement, the lever can be moved ergonomically for an operator in a favorable manner, particularly when the lever is arranged in the area of a bumper unit since it is particularly favorable for an operator for the purpose of developing force during actuation of the lever in this area when the operator has to move the lever in a plane deviating only slightly from the horizontal plane.

One particularly advantageous solution provides, in this respect, for the plane of movement to be arranged in the area of a bumper unit.

It is particularly favorable when the plane of movement is arranged in a lower area of the bumper unit facing a roadway.

In order to configure the lever to be as optically inconspicuous as possible, it is expediently provided for the lever to have a cross sectional shape which has a greater extension in the plane of movement than at right angles to it.

In this respect, the lever is preferably of an oval design in cross section or consists of flat material. This has the advantage, in particular, with the course of the plane of movement according to the invention that the dimensions of the lever are hardly noticeable optically when viewed in a direction parallel to the plane of movement.

With respect to the attachment of the lever base relative to the vehicle body, no further details have so far been given. It would, for example, be conceivable to arrange and fix the lever base directly on an upper surface of part of the vehicle body.

However, in order to be able to mount the lever base in as stable a manner as possible relative to the vehicle body, it is preferably provided for the lever base to be held on a support anchored on the vehicle body and provided for the impact of a load.

The support could be provided for any optional type of load impact. A particularly favorable solution provides for the support to comprise a transverse support bearing the trailer coupling.

Such a transverse support offers the advantage that it is already configured for a heavy load and anchored on the vehicle body in a correspondingly stable manner so that a stable mounting of the lever base is provided at the same time.

In this respect, it is favorable, in particular, when the lever base is arranged independently of a bumper unit and, therefore, is not held or stabilized by the bumper unit.

In addition, the invention relates to a motor vehicle comprising a trailer coupling with a bearing unit arranged securely on the vehicle, with a ball neck movable in relation to the bearing unit between an operative position and a rest position and with a manual actuating device, by means of which the trailer coupling, in particular, a locking device of such a trailer coupling can be actuated via a movement transfer device.

The problem with such motor vehicles is that the installation of the actuating device is complicated since this normally takes place in a trunk of the vehicle.

The object underlying the invention is, therefore, to design a motor vehicle with a trailer coupling which is as easy as possible to install.

This object is accomplished in accordance with the invention, in a motor vehicle of the type specified above, in that the actuating device and the actuation transfer device are arranged outside the vehicle body free from any openings in the vehicle body.

The advantage of this solution is to be seen in the fact that, as a result, the installation of the trailer coupling with actuating device is simplified considerably since, as a result, a preliminary assembly of a unit consisting of trailer coupling, actuating device and actuation transfer device is possible and, therefore, the entire unit can be mounted on the vehicle without any additional measures.

This is also a considerable advantage during any subsequent fitting of such a trailer coupling since, as a result, no additional openings whatsoever in the vehicle body need to be provided at considerable expense and also sealed.

It is particularly expedient when the actuating device and the trailer coupling are arranged on a transverse support on the vehicle body which is provided, in any case, for receiving the trailer coupling.

This transverse support can be mounted outside the body of the vehicle in a simple manner and, therefore, the actuating device with it, as well.

In this respect, it is expediently provided for the transverse support to be covered by a bumper unit.

With respect to the arrangement of the manual actuating device relative to the bearing unit, no further details have so far been given.

In order to provide ergonomically favorable access to the actuating device, it is preferably provided for the actuating device to be arranged on a side of the bearing unit located opposite the rest position of the ball neck.

Furthermore, no further details have been given with respect to the arrangement of the actuating device in conjunction with the bearing unit.

It would, for example, be conceivable to arrange the actuating device on the bearing unit.

It is, however, even more favorable when the actuating device is arranged next to the bearing unit of the trailer coupling.

Ergonomic access to the actuating device can be realized in a particular simple manner when the actuating device is arranged at a distance from the bearing unit.

In addition, no further details have been given with respect to the design of the manual actuating device. One expedient solution provides for the actuating device to comprise a lever base held by the transverse support and a movable lever.

In this respect, it is likewise particularly favorable, in order to be able to mount the actuating device independently of the vehicle body and the bumper, when the lever base is arranged independently of the bumper unit.

One particularly favorable solution provides for the lever to be arranged in the area of the bumper unit so as to be accessible.

The accessibility of the lever may be realized in a particularly expedient manner when the lever is arranged in the area of an underside of the bumper unit.

The lever could, in principle, be movable in various directions. One optimum solution with respect to an optically favorable arrangement of the lever and a simple actuation provides for the lever to be movable in a plane of movement which forms an angle of at the most approximately 30° with a horizontal plane, even better of at the most 20° and even more favorable of at the most 10°.

It is even more advantageous when the plane of movement extends approximately horizontally.

A further, favorable solution provides for the plane of movement to be arranged in the area of one side of the bumper unit.

This side is, for example, the underside of the bumper unit and so the plane of movement is aligned approximately in a similar manner to how an underside of the bumper unit extends.

With respect to the optical appearance of the lever, no further details have likewise been given thus far. For example, it would be conceivable to design the lever as a round lever. It is, however, particular favorable when the lever has a cross sectional shape which has a greater extension in its plane of movement than at right angles to this.

In order for there to be as little optical influence on the appearance of the motor vehicle as possible, it is preferably provided for the bumper unit to be provided with a cutout for the actuating device so that it is not the entire bumper unit which has to be adjusted to the arrangement of the actuating device.

It is particularly advantageous when the bumper unit is provided with a cutout for the ball neck and with the cutout for the actuating device separate from it so that there is as little influence as possible on the elements of the vehicle body altogether defining the optical appearance of the motor vehicle.

Additional features and advantages of the invention are the subject matter of the following description as well as the drawings illustrating several embodiments.

### BRIEF DESCRIPTION OF THE DRAWINGS

FIG. 1 shows a plan view of a rear end of a body of a motor vehicle with a bumper unit and a trailer coupling together with an actuating device according to the invention;

FIG. 2 shows a section along line 2-2 in FIG. 1;

FIG. 3 shows a plan view in the direction of arrow A in FIG. 1;

FIG. 4 shows an illustration of attachment of trailer coupling and actuating device to a transverse support covered by the bumper unit;

FIG. 5 shows a plan view similar to FIG. 3 with the bumper unit removed;

FIG. 6 shows a section along line 6-6 in FIG. 5;

FIG. 7 shows a plan view similar to FIG. 5 of the first embodiment of the actuating device according to the invention in actuating position;

FIG. 8 shows a plan view similar to FIG. 5 of the first embodiment of the actuating device according to the invention in starting position but with a securing device released;

FIG. 9 shows a section according to FIG. 6 through a second embodiment of an actuating device according to the invention and

FIG. 10 shows a section similar to FIG. 6 through a third embodiment of an actuating device according to the invention.

### DETAILED DESCRIPTION OF THE INVENTION

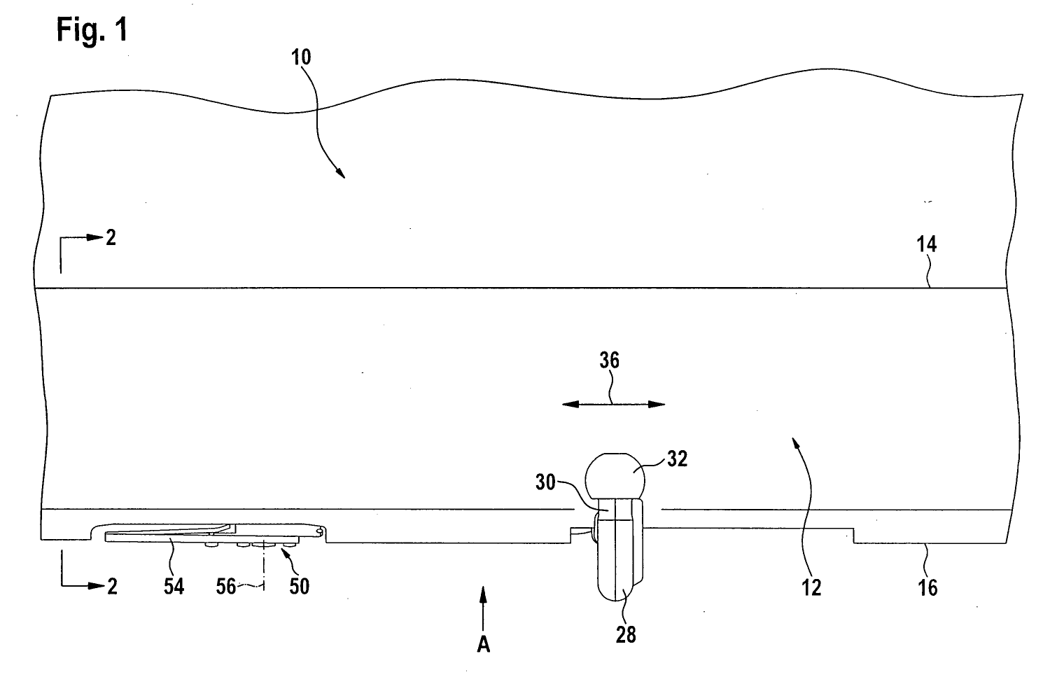

A rear end of a motor vehicle illustrated in FIG. 1 and designated as a whole as 10 is provided with a bumper unit 12 which represents a lower termination of the rear end 10, wherein the bumper unit 12 has an upper side 14 extending away from the rear end 10, a rear side 16 extending downwards from the upper side 14 and an underside 18 again extending from the rear side 16 in the direction of the rear end 10.

Furthermore, the bumper unit 12 covers a transverse support 20 which extends transversely to a longitudinal direction 22 of the motor vehicle to receiving means provided laterally on the vehicle body.

A bearing unit of a trailer coupling 26, designated as a whole as 24, is held on the transverse support 20 and, in particular, beneath it, wherein the bearing unit 24 forms a pivotable bearing for a ball neck 28 which bears a coupling ball 32 at its angled end 30 facing away from the bearing unit.

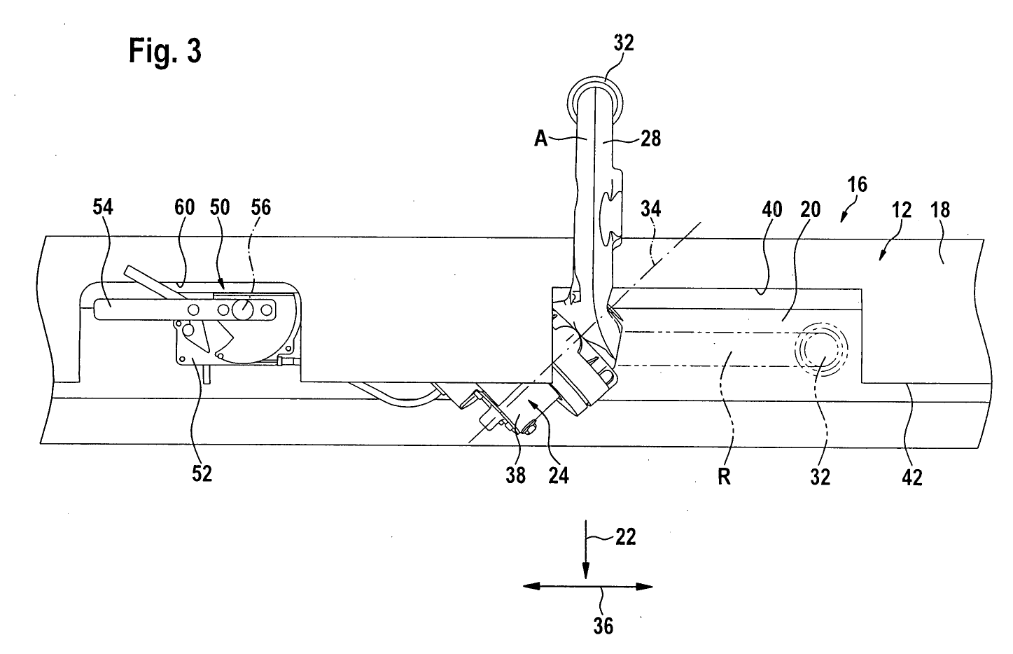

As illustrated in FIG. 3, the bearing unit 24 is designed such that the ball neck 28 is pivotable about a pivot axis 34 which extends at an angle to the longitudinal direction 22 of the vehicle and, in addition, at an angle to a horizontal direction 36.

The bearing unit 24 comprises, in addition, a locking device 38 which locks the ball neck 28 in its operative position A and its rest position R.

In order to make it possible for the ball neck 28 to move due to pivoting about the pivot axis 34 from its operative position A shown in FIG. 3 by solid lines into its rest position R which is illustrated in FIG. 3 by dash dot lines and in which the ball neck 28 is arranged, with a coupling ball 32 facing downwards, i.e., facing the underside 18, beneath the transverse support 20 and extending approximately in the same direction as the support and covered by the bumper unit 12, the underside 18 of the bumper unit 12 is provided with a cutout which is designated as a whole as 40, extends in the underside 18 from an end edge 42 facing the rear end 10 in the direction of the rear side 16 but ends at a distance from the rear side 16 and is dimensioned such that the entire ball neck 28 extending from the bearing unit 24 can be moved through the cutout 40 in the underside 18 with the coupling ball 32. In order to actuate the locking device 38, an actuating device 50 which is likewise at least partially covered by the bumper unit 12 is provided on a side of the bearing unit 24 located opposite the rest position R of the ball neck 28 outside the vehicle body, i.e., in this case the rear end 10 and this actuating device has a device base 52, on which a lever 54 is mounted so as to be pivotable about an axis 56.

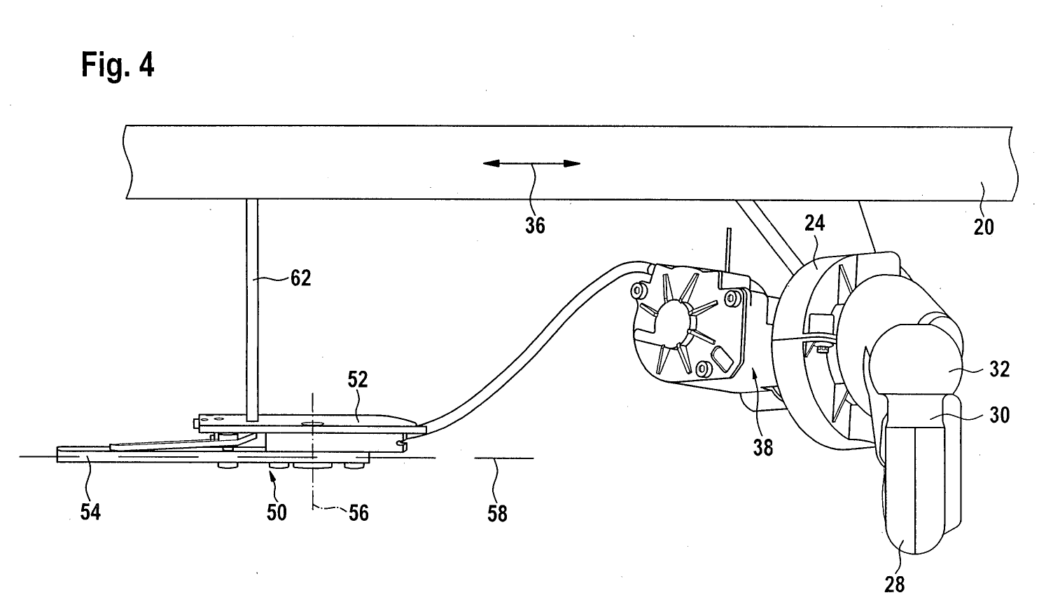

The axis 56 is, as illustrated in FIG. 4, essentially vertical so that the lever 54 is movable in a plane 58 which extends approximately parallel to the horizontal 36 but drops slightly downwards, i.e., in the direction of a roadway with increasing distance from the rear end 10.

As a result, the actuating device 50, as illustrated in FIG. 1, is at least partially covered by the bumper unit 12, wherein in order to make the lever 54 accessible the underside 18 is likewise provided with a cutout 60 which extends from the end edge 42 of the underside 18 in the direction of the rear side 16 of the bumper unit 12 but ends at a distance from it, wherein the lever 54 is essentially accessible via the cutout 60, as illustrated, in particular, in FIG. 1 whereas the device base 52 is covered to a great extent by the bumper unit 12.

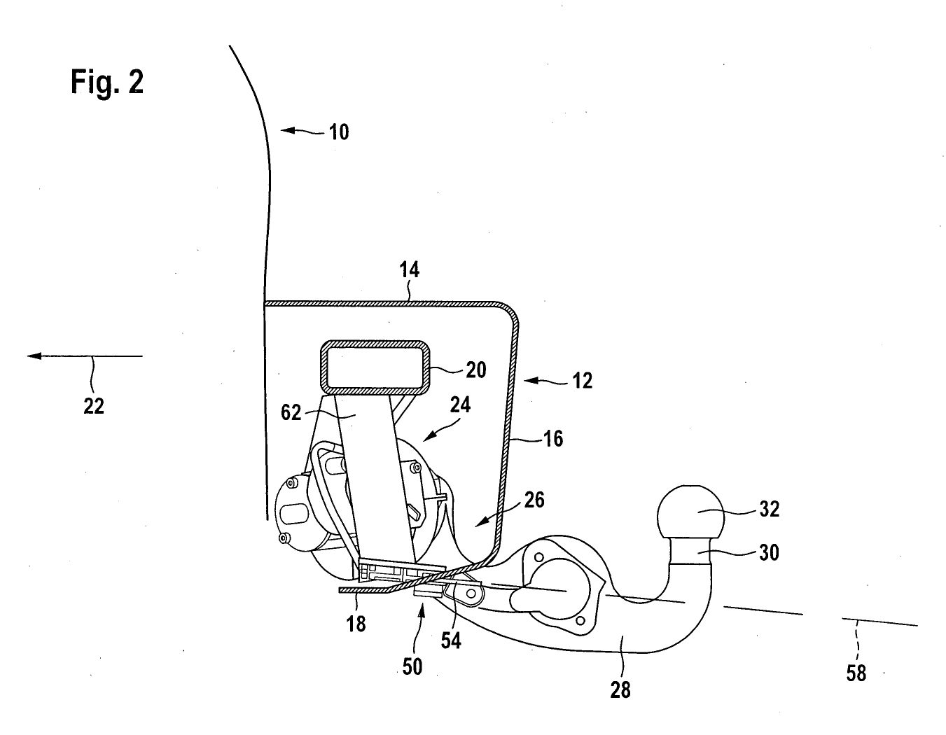

For the purpose of its independent fixing in position, the device base 52 is connected to the transverse support 20 via a support 62 at a distance from the bearing unit 24, as illustrated in FIGS. 2 and 4, and so the device base 52 is positioned and held relative to the rear end 10 of the vehicle body completely independently of the bumper unit 12.

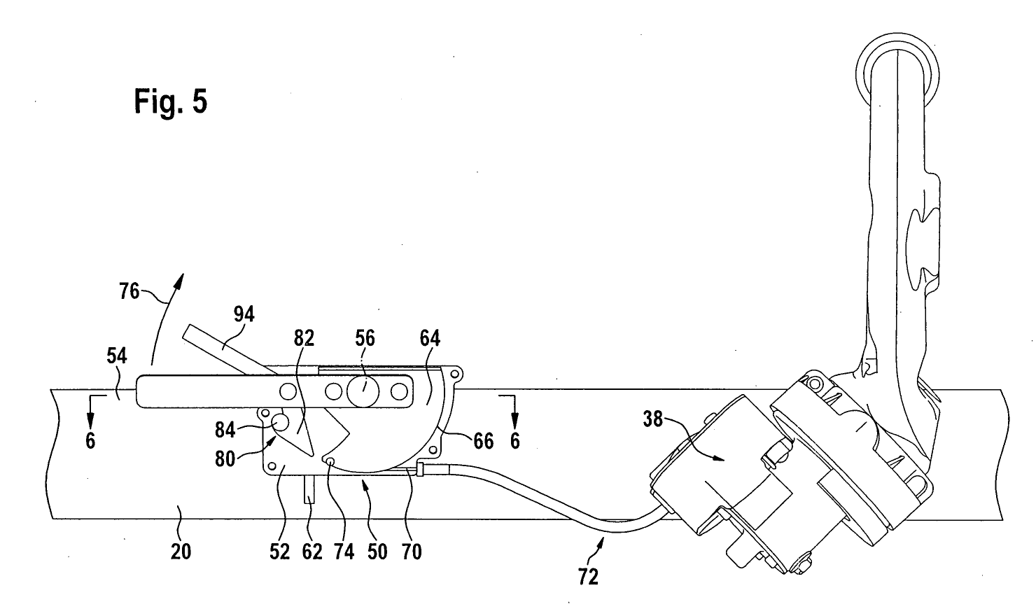

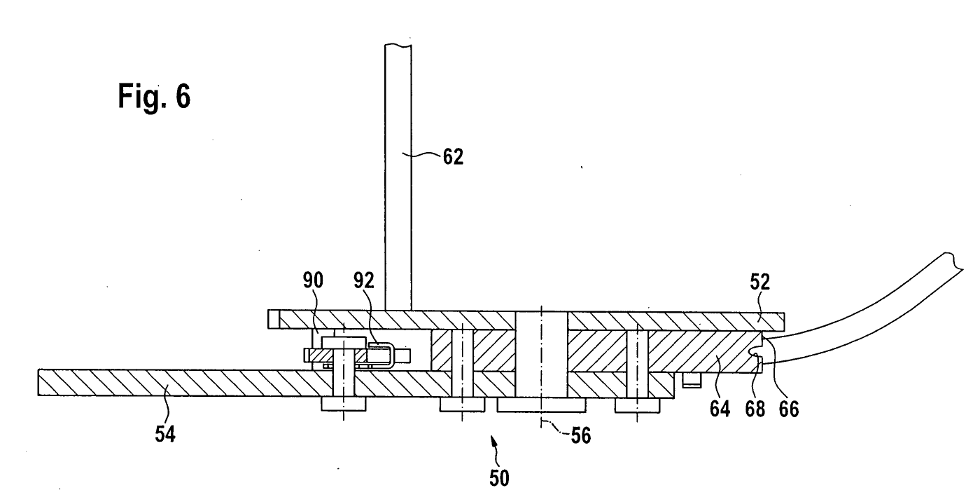

As illustrated in FIGS. 5 and 6, the lever 54 is connected to a guide member 64 which has an outer contour 66 designed as a circular segment, in which, as illustrated in FIG. 6, a groove runs which is designed as a recess and serves the purpose of accommodating a traction cable 70 of a cable line designated as a whole as 72 which is operative as a movement transfer device between the actuating device 50 and the locking device 38, wherein the actuation transfer device 72 also extends outside the vehicle body 10 and covered by the bumper unit 12.

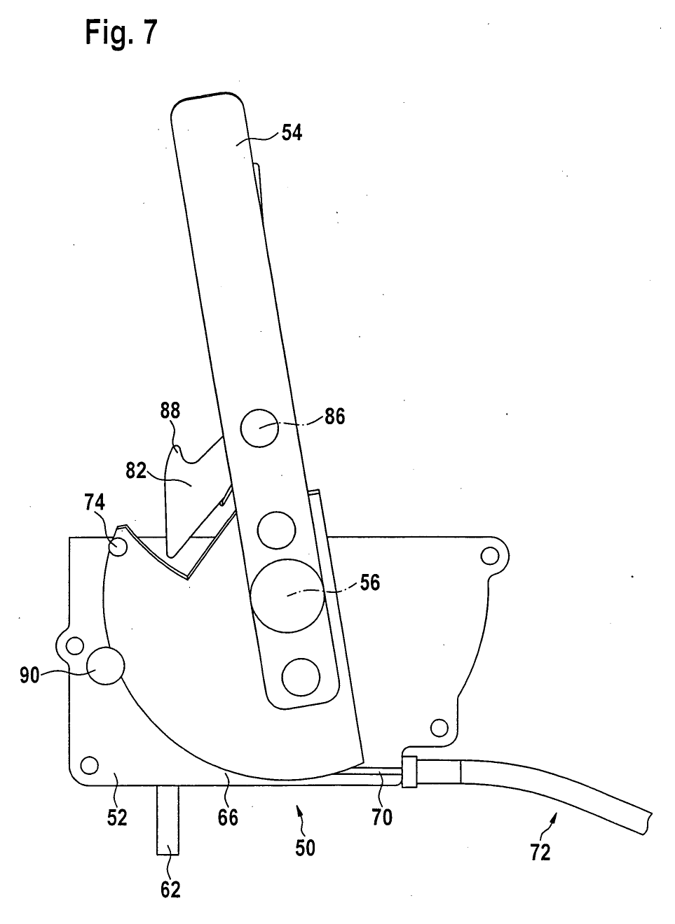

The traction cable 70 is connected to the guide member 64 by a holding element 74 and so the lever 54 pivots in an actuating direction 76 as a result of it being pulled away from the bumper device 12 and, therefore, as illustrated in FIG. 7, pulls on the traction cable 70 in such a manner that this slides into the groove 68 essentially along the outer contour 66.

In order to prevent the lever 54 being pivoted unintentionally in the direction of the actuating direction 76, the actuating device 50 is also provided with a securing device which is designated as a whole as 80 and has, on the one hand, a securing element 82 as well as a securing element receiving means 84.

The securing element 82 is designed in the first embodiment as a locking detent pivotable about an axis 86 and having a locking nose 88 which engages behind a securing element receiving means 84 designed as a pin 90 in order to secure the lever 54 in the starting position. For this purpose, the securing element 82 is acted upon with a spring 92 such that the locking nose 88 always has the tendency to transfer into the position engaging behind the pin 90.

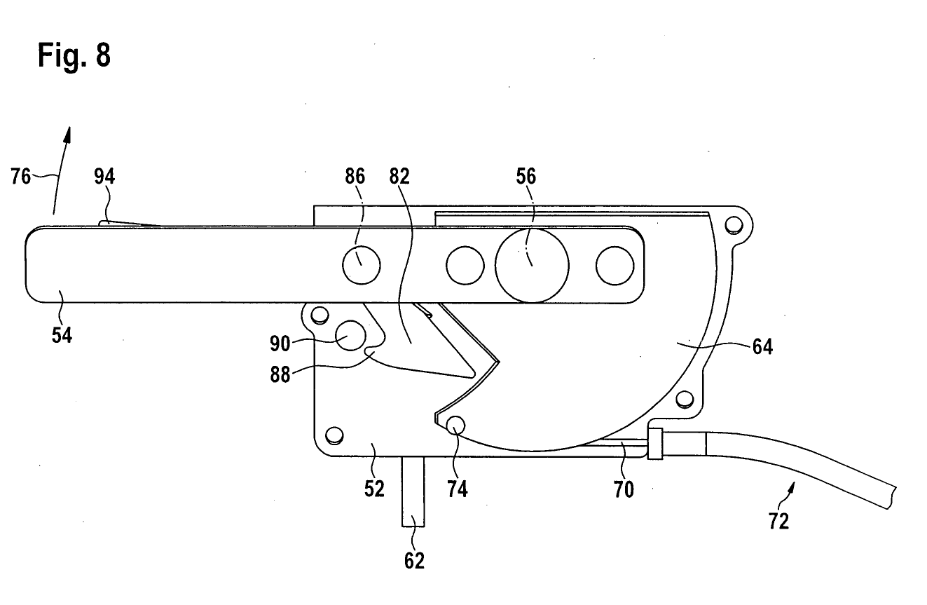

In order to release the securing element 82 designed as a locking detent, this is connected to a releasing lever 94 which extends at an acute angle to the lever 54 in the locking position of the securing element 82 and is movable in the direction of the lever 54 in order to release the securing element 82, wherein, in this case, as illustrated in FIG. 8, the securing element 82 designed as a locking detent pivots about the axis 86 to such an extent that the locking nose 88 can be moved past the pin 90 and, consequently, the lever 54 can be pivoted in the actuating direction 76 from the starting position illustrated in FIG. 5 into the actuating position illustrated in FIG. 7. This pivoting of the lever 54 causes a pull on the traction cable 70 and, therefore, action on the locking device 38 in such a manner that the locking of the pivoting movement of the ball neck 28 about the pivot axis 34 is released and, therefore, the ball neck 28 can be pivoted back and forth between the rest position R and the operative position A.

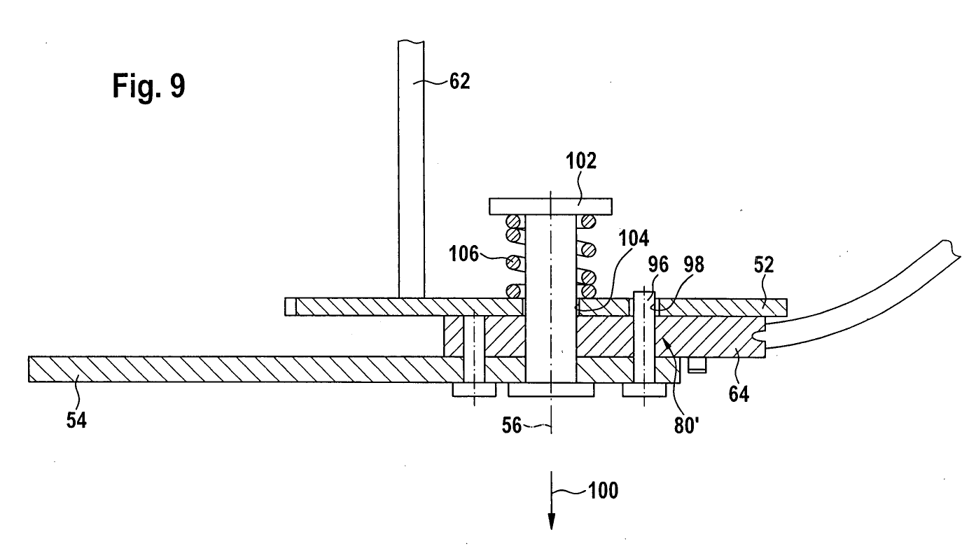

In a second embodiment, illustrated in FIG. 9, the securing device 80′ is designed in such a manner that a locking pin 96 engages with a locking recess 98 in the device base 52 in order to secure the lever 54 in the starting position.

The securing device 80′ is now releasable in that the lever 54, together with the guide member 64, can be displaced in a release direction 100 to such an extent until the locking pin 96 no longer engages with the locking recess 98 and the lever 54 can be rotated about the axis 56 with the guide member 64.

For this purpose, the lever 54 with the guide member 64 is held on a bearing bolt which is designated as a whole as 102 and, for its part, is mounted for rotation in a bearing opening 104 in the device base 52 and, on the other hand, is acted upon by a spring 106 in such a manner that the lever 54 with the guide member 64 is always acted upon in the direction of the device base 52 so that when the lever 54 is not acted upon the locking pin 96 engages in the locking recess 98 and the locking pin 96 disengages from the locking recess 98 only when the lever 54 is acted upon in release direction 100.

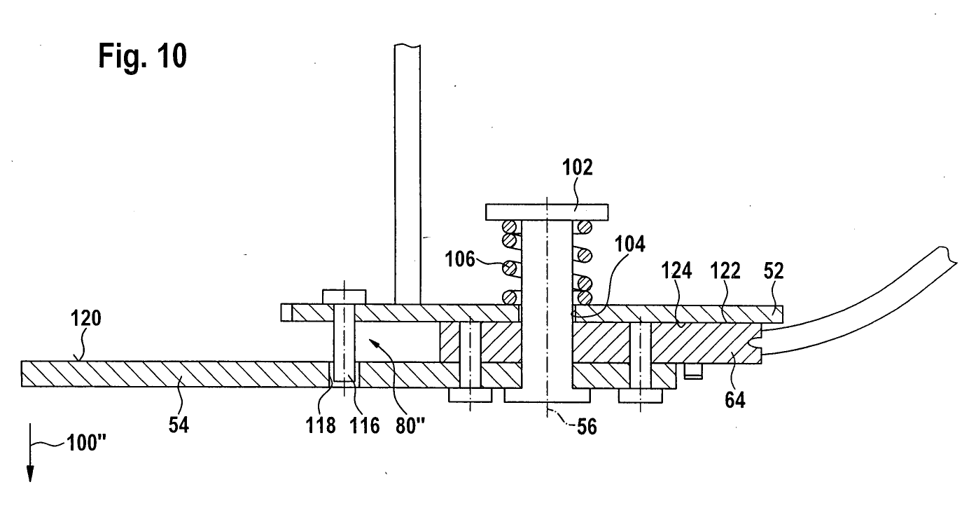

In a third embodiment, illustrated in FIG. 10, the device base 52 itself is provided with a locking pin 116 which can be brought into engagement with a locking recess 118 in the lever 54 itself, wherein the locking recess 118 is arranged in an area located between a contact surface 120 of the lever 54 and the axis 56.

Due to tilting the lever 54 as a result of the fact that this is acted upon in the area of the hand contact surface 120, the lever may be moved to such an extent that the locking recess 118 disengages from the locking pin 96.

For this purpose, the bearing bolt 102 is mounted with clearance in the bearing opening 104 and is likewise acted upon by the spring 106 such that it has the tendency to abut the guide member 64 with its contact side 122 on a contact side 124 of the device base 52 whereas during action on the hand contact surface 120 in the release direction 102′ the guide member 64 can lift away from the contact side 124 at least with parts of its contact side 122 in order to bring the locking recess 118 at least partially out of engagement with the locking pin 116.

1. Actuating device for a trailer coupling, in particular, for actuating a trailer coupling with a ball neck movable between an operative position and a rest position, for example, a locking device of such a trailer coupling, comprising
a device base adapted to be mounted on the vehicle and a lever mounted on the device base so as to be movable, said lever being movable from a starting position, no actuation of the trailer coupling taking place in said position, into an actuating position, the trailer coupling being acted upon by means of a movement transfer device, a securing device being provided on the lever, said securing device securing the lever against any actuation in the starting position.

2. Actuating device as defined in claim 1, wherein the securing device comprises a securing element adapted to be brought into operative connection with a securing element receiving means on the device base in order to secure the lever on the device base in the starting position.

3. Actuating device as defined in claim 2, wherein the securing element is acted upon by an elastic force storing means in the direction of its position interacting with the securing element receiving means.

4. Actuating device as defined in claim 1, wherein the securing element is adapted to be brought out of operative connection with the securing element receiving means in conjunction with action on the lever.

5. Actuating device as defined in claim 4, wherein the securing device comprises an actuatable releasing element, the securing element being adapted to be brought into a position out of operative connection with the securing element receiving means with said releasing element.

6. Actuating device as defined in claim 5, wherein the releasing element is movable in relation to the lever.

7. Actuating device as defined in claim 5, wherein the releasing element is mounted on the lever so as to be movable.

8. Actuating device as defined in claim 5, wherein the releasing element is a releasing lever.

9. Actuating device as defined in claim 8, wherein the releasing lever is pivotable in the direction of the lever for the purpose of actuation.

10. Actuating device as defined in claim 1, wherein the securing element is adapted to be brought out of operative connection with the securing element receiving means due to action on the lever in a release direction extending transversely to the direction of movement leading from the starting position to the actuating position.

11. Actuating device for a trailer coupling, in particular, for actuating a trailer coupling with a ball neck movable between an operative position and a rest position, for example, a locking device of such a trailer coupling, comprising a device base adapted to be mounted on the vehicle and a lever mounted on the device base so as to be movable, said lever being movable from a starting position, no actuation of the trailer coupling taking place in said position, into an actuating position, the trailer coupling being acted upon by means of a movement transfer device, the lever being arranged on an outer side of the vehicle body so as to be accessible.

12. Actuating device as defined in claim 11, wherein the lever is arranged so as to be constantly accessible from an outer side of the vehicle body.

13. Actuating device as defined in claim 11, wherein the lever is arranged in the area of a bumper unit.

14. Actuating device as defined in claim 13, wherein the lever is arranged in the area of an underside of the bumper unit.

15. Actuating device for a trailer coupling, in particular, for actuating a trailer coupling with a ball neck movable between an operative position and a rest position, for example, a locking device of such a trailer coupling, comprising a device base adapted to be mounted on the vehicle and a lever mounted on the device base so as to be movable, said lever being movable from a starting position, no actuation of the trailer coupling taking place in said position, into an actuating position, the trailer coupling being acted upon by means of a movement transfer device, the lever being movable in a plane of movement forming an angle of at the most approximately 30° with a horizontal plane.

16. Actuating device as defined in claim 15, wherein the plane of movement extends approximately horizontally.

17. Actuating device as defined in claim 15, wherein the plane of movement is arranged in the area of a bumper unit.

18. Actuating device as defined in claim 17, wherein the plane of movement is arranged in a lower area of the bumper unit facing a roadway.

19. Actuating device as defined in claim 15, wherein the lever has a cross sectional shape having a greater extension in the plane of movement than at right angles to it.

20. Actuating device for a trailer coupling, in particular, for actuating a trailer coupling with a ball neck movable between an operative position and a rest position, for example, a locking device of such a trailer coupling, comprising a device base adapted to be mounted on the vehicle and a lever mounted on the device base so as to be movable, said lever being movable from a starting position, no actuation of the trailer coupling taking place in said position, into an actuating position, the trailer coupling being acted upon by means of a movement transfer device, the lever base being held on a support anchored on the vehicle body and provided for the impact of a load.

21. Actuating device as defined in claim 20, wherein the support comprises a transverse support bearing the trailer coupling.

22. Actuating device as defined in claim 1, wherein the lever base is arranged independently of a bumper unit.

23. Motor vehicle comprising a trailer coupling with a bearing unit arranged securely on the vehicle, with a ball neck movable in relation to the bearing unit between an operative position and a rest position and with a manual actuating device, the trailer coupling, in particular, a locking device of such a trailer coupling being actuatable by means of said actuating device via a movement transfer device, wherein the actuating device and the actuation transfer device being arranged outside the vehicle body free from any openings in the vehicle body.

24. Motor vehicle as defined in claim 23, wherein the actuating device and the trailer coupling are arranged on a transverse support.

25. Motor vehicle as defined in claim 24, wherein the transverse support is covered by a bumper unit.

26. Motor vehicle as defined in claim 23, wherein the actuating device is arranged on a side of the bearing unit located opposite the rest position of the ball neck.

27. Motor vehicle as defined in claim 23, wherein the actuating device is arranged next to the bearing unit of the trailer coupling.

28. Motor vehicle as defined in claim 26, wherein the actuating device is arranged at a distance from the bearing unit.

29. Motor vehicle as defined in claim 23, wherein the actuating device comprises a lever base held by the transverse support and a movable lever.

30. Motor vehicle as defined in claim 29, wherein the lever base is arranged independently of a bumper unit.

31. Motor vehicle as defined in claim 29, wherein the lever is arranged in the area of the bumper unit so as to be accessible.

32. Motor vehicle as defined in claim 31, wherein the lever is arranged in the area of an underside of the bumper unit.

33. Motor vehicle as defined in claim 29, wherein the lever is movable in a plane of movement forming an angle of at the most approximately 30° with a horizontal plane.

34. Motor vehicle as defined in claim 33, wherein the plane of movement extends approximately horizontally.

35. Motor vehicle as defined in claim 33, wherein the plane of movement is arranged in the area of one side of the bumper unit.

36. Motor vehicle as defined in claim 33, wherein the plane of movement is arranged in a lower area of the bumper unit facing a roadway.

37. Motor vehicle as defined in claim 29, wherein the lever has a cross sectional shape having a greater extension in its plane of movement than at right angles to it.

38. Motor vehicle as defined in claim 25, wherein the bumper unit is provided with a cutout for the actuating device.

39. Motor vehicle as defined in claim 38, wherein the bumper unit is provided with a cutout for the ball neck and the cutout for the actuating device separate from it.

40. Motor vehicle as defined in claim 29, wherein the actuating device comprising
a device base adapted to be mounted on the vehicle and a lever mounted on the device base so as to be movable, said lever being movable from a starting position, no actuation of the trailer coupling taking place in said position, into an actuating position, the trailer coupling being acted upon by means of a movement transfer device, a securing device being provided on the lever, said securing device securing the lever against any actuation in the starting position.
